(19) United States
(12) Patent Application Publication
(10) Pub. No.: US 2010/0186220 A1
(43) Pub. Date: Jul. 29, 2010

(54) FABRICATION METHOD OF METAL SUPPORTED SOLID OXIDE FUEL CELL

(75) Inventors: Joongmyeon BAE, Daejeon (KR); Yu-Mi KIM, Daejeon (KR); Changbo LEE, Daejeon (KR); Seung-Wook BAEK, Daejeon (KR); Gyujong BAE, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: KOREA ADVANCED INSTITUTE OF SCIENCE AND TECHNOLOGY, Daejeon (KR)

(21) Appl. No.: 12/612,900

(22) Filed: Nov. 5, 2009

(30) Foreign Application Priority Data
Nov. 6, 2008 (KR) 10-2008-0109694

(51) Int. Cl. H01M 8/00

(52) U.S. Cl. 29/623.1

(57) ABSTRACT

Provided is a fabrication method of a metal supported solid oxide fuel cell (SOFC) which comprises a metal supporter, and an anode layer, an electrolyte and a cathode layer stacked in turn on the metal supporter. The fabrication method includes forming the anode layer and the electrolyte on the metal supporter; forming the green cathode layer by coating on the electrolyte a cathode slurry containing a cathode material; and in-situ sintering the green cathode layer by a normal operation of the metal supported SOFC.

### TECHNICAL FIELD

The present invention relates to a fabrication method of a metal supported solid oxide fuel cell; and, more particularly, to a fabrication method of a metal supported solid oxide fuel cell which includes a metal supporter, an anode, an electrolyte, a cathode layer and in which the cathode layer is formed by in-situ sintering.

### BACKGROUND ART

In general, a solid oxide fuel cell (SOFC) is an energy conversion device in which chemical energy of fuel gas is directly converted into electric energy by an electrochemical reaction. Since a potential difference obtained from one basic unit cell comprised of an anode, an electrolyte and a cathode is about 1V, it is necessary to construct a fuel cell system having a fuel cell stack, in which a plurality of unit cells are connected in series or parallel with each other, in order to use the fuel cell as a power source.

Since the SOFC system uses a method of direct generation of electric power, which is not necessary for combustion processes and mechanical actions unlike in existing thermal power generation, it has a high electric power generation efficiency of 40˜60% and also it has a substantially constant efficiency over a wide load range, e.g., 25-100% of rated power.

And the SOFC system is an eco-friendly technology that 30% or more of CO₂ emissions can be reduced, and its NOx, SO₂ and particle emissions is very small and thus can be ignored because it has not the combustion process, and its operation noise/vibration is immaterial.

The SOFC system can be used as a middle/large-scaled power generation system of 100 kW˜a few tens MW class, a small-scaled home power generation system of 1 kW ˜10 kW class and a mobile power generation system of a few W˜a few kW class.

According to the electrochemical reaction of the SOFC, in an anode thereof, hydrogen releases electrons and reacts with oxygen ions moved through an electrolyte to generate water and heat. The electrons generated in the anode move to a cathode while generating direct current through an external circuit and then combine with oxygen in the cathode to generate oxygen ions. The generated oxygen ions move through the electrolyte to the anode.

The anode of the SOFC is formed of Ni/YSZ cermet, Ru/YSZ cermet, Ni/SDC cermet, Ni/GDC cermet, Ni, Ru, Pt and the like, and the electrolyte is formed of ZrO₂ system (CaO, MgO, Sc₂O₃, Y₂O₃ doped ZrO₂), CeO₂ system (Sm₂O₃, Gd₂O₃, Y₂O₃ doped CeO₂), Bi₂O₃ system (CaO, SrO, BaO, Gd₂O₃, Y₂O₃ doped Bi₂O₃), perovskite oxide ((La,Sr)(Ga,Mg)O_{3-δ}, Ba(Ce,Gd)O_{3-δ}) and the like, and the cathode is formed of LaMnO₃ system (La(Sr, Ca)MnO₃, (Pr,Nd,Sm)SrMnO₃ and the like), LaCoO₃ system ((La, Sr)CoO₃, (La, Sr)(Co,Fe)O₃, (La, Ca)CoO₃ and the like), Ru, Pt and the like.

Until now, the SOFC has been formed into three types, i.e., a cylindrical type, a flat plate type and an integral type. The cylindrical type and the flat plate type SOFCs have been mainly developed.

A flat plate type anode-supported SOFC meets various requirements such as output property, long-term operation property and heat cycle property. However, it has still some problems such as sealing, thermal shock and mechanical strength.

In the flat plate type anode-supported SOFC, the sealing problem leads to a restriction on the fabricating of the SOFC and the operation efficiency thereof. Further, since the SOFC has a weak mechanical strength, it may be damaged by thermal dynamic operation or external shock.

To solve the above mentioned problems, there has been developed a metal supported SOFC.

The metal supported SOFC is a new conceptual SOFC in which a metal supporter is used instead of an anode of the conventional anode-supported SOFC so as to reduce a thickness of a ceramic element, thereby enhancing the mechanical strength and the sealing efficiency. In the metal supported SOFC, since the metal supporter also functions as a separator in a ceramic supported SOFC, the sealing problem between the anode and the separator can be solved. And, since a metal working process can be easier than a ceramic working process, it is possible to improve the performance of the fuel cell through a passage forming process. Furthermore, if a fabricating process thereof is further developed, it will be possible to remarkably reduce a fabricating cost.

In order to embody and commercialize the SOFC, it is important to reduce a cost thereof, particularly, reduce a cost of a system including a stack structure thereof. Further, in order to expand an application scope of the SOFC, it is indispensable that the system thereof should be much leaner and lighter. To this end, it is necessary to develop a low-priced new material, a compact stack system, a high-density hydrogen storage technique and a fuel reforming technique.

The metal supported SOFC is a new technology for providing a light weight and a small size of the system as well as a simple and low-priced fabricating process. This technology further provides high strength, high sealing ability and thermal stability, and it also solves the problems that temperature declination is aggravated due to using of a conventional ceramic supporter and thus slow heat transferring, and the conventional SOFC is weak for vibration and shock.

As techniques published in non-patent documents, there are a technique of stacking a ceramic cell (a unit cell) on a porous metal supporter, a technique of in-situ sintering a ceramic cell after semi-sintering a metal generated by powder metallurgy, a technique of coating the ceramic cell on the metal supporter, a technique of integrally sintering a metal separating plate, a passage and a ceramic cell as a single module, and the like.

As some examples of the metal supported SOFC published in patent documents, International Publication No. WO2004/012287 discloses a tubular solid oxide fuel cell which includes a tubular, substantially metallic porous support layer and a tubular, functional layer assembly in concentric adjacent contact with the support layer. In Korean Patent Publication No. 2007-007739, there is disclosed a fabricating method of a cylindrical metal supported SOFC which includes an anode formed by repeatedly impregnating and heating a previously calcined porous YSZ layer in a Ni aqueous solution.

In International Publication No. WO2006/019295, there is disclosed a SOFC stack concept in which a metal supported SOFC is used as a basic unit. And in Japanese Patent Publication No. 2006-73401, there is disclosed an SOFC having a new structure that a ceramic cell (a unit cell) is formed in fine holes of a metal supporter.

Electrodes (anode and cathode) of the metal supported SOFC is typically fabricated by using various coating methods of each raw material powder, such as screen-printing, spraying, dipping and the like, and then performing heat treatment (sintering) at 1000° C. or more.

In case of (La,Sr)MnO₃ or (La,Sr)(Co,Fe)O₃ as the material for forming the cathode, the heat treatment at 1200° C. or more is needed even in a ceramic supported SOFC. If the heat treatment is performed at 1000° C. or less, adhesion between the electrodes and the electrolyte is deteriorated, and thus the electrodes may be disintegrated. Therefore, the sintering temperature is very important.

Further, pores are formed in the cathode so that the oxygen reduction reaction can be smoothly performed, and thus it is not always preferable to just increase the sintering temperature so as to enhance the adhesion. The diffusion of atoms may be occurred at a too high temperature and it exerts a bad effect on the performance of the fuel cell. Therefore, it can be understood that the sintering temperature having relation to the performance is an important parameter.

However, in case of the metal supported SOFC, the electrodes cannot be previously heat-treated at the temperature of 1000° C. or more due to the property of the metal supporter and the structural problem thereof.

If the metal supported SOFC is sintered, the metal is oxidized and a heat resistance problem arises. Therefore, in the metal supported SOFC, the sintering of the electrodes, particularly, the cathode is very important.

As a result of extensive experiments and efforts, the applicant has developed a new manufacturing method which can prevent the degradation of the metal supporter and also form the cathode layer without separate sintering of the cathode layer, and also has extracted a cathode material which can form the excellent cathode layer using the manufacturing method of the present invention.

### DISCLOSURE

### Technical Problem

An embodiment of the present invention is directed to providing a fabrication method of a metal supported solid oxide fuel cell which can prevent the degradation of the metal supporter and also form a stable and excellent cathode layer without separate sintering process.

### Technical Solution

To achieve the object of the present invention, the present invention provides a fabrication method of a metal supported solid oxide fuel cell (SOFC) which includes a metal supporter, and an anode layer, an electrolyte and a cathode layer stacked in turn on the metal supporter, including forming the anode layer and the electrolyte on the metal supporter; forming the green cathode layer by coating on the electrolyte a cathode slurry containing a cathode material; and in-situ sintering the green cathode layer by an normal operation of the metal supported SOFC.

The in-situ sintering means that the green cathode layer is sintered during a heating process to a normal operation temperature for the normal operation of the SOFC or a heating and normally operating process of the SOFC without separate heat treatment for sintering the green cathode layer.

Preferably, the green cathode layer means a solid state that the cathode slurry is coated on the electrolyte and dried so that a liquid component contained in the slurry is volatilized. However, since the drying can be performed during an early stage of the in-situ sintering (an initial heating stage for the normal operation), it does not matter that the drying is not performed before the in-situ sintering.

The fabrication method of a metal supported SOFC includes forming a green cathode by coating a cathode slurry on an electrolyte layer of a half cell in which an anode layer and the electrolyte layer are stacked in turn on a metal supporter; and heating the metal supported SOFC to an operation temperature and operating it in a state that the green cathode layer is not sintered.

Substantially, the fabrication method of the present invention includes preparing a half cell having the anode layer and the electrolyte by sintering a green cell in which an anode sheet and an electrolyte sheet are stacked, a green cell in which a previously sintered pellet type anode layer and the electrolyte sheet are stacked, or a green cell in which the anode sheet and a previously sintered thin film type electrolyte layer are stacked; bonding the anode layer of the half cell and the metal supporter; forming the green cathode layer by coating a cathode slurry on the electrolyte layer of the half cell; and heating the metal supported SOFC to an operation temperature and then operating it in a status that the green cathode layer is not sintered.

In the fabrication method of the SOFC according to the present invention, the cathode layer of the metal supported SOFC is formed by the in-situ sintering.

The present invention is not limited by a shape of the metal supporter, a material forming each of the anode layer and the electrolyte, a shape (including dimension) of each of the anode layer and the electrolyte layer, a bonding method of the metal supporter and the anode layer and the like. However,

Preferably, in consideration of the preferable cathode material for the cathode layer of the present invention, a material of the electrolyte layer contacted with the cathode layer has high interface adhesion (including physical interface adhesion, and interface adhesion with respect to thermal shock and heat cycle).

In order to form the cathode layer having preferable electrochemical property using the in-situ sintering, the cathode material contained in the cathode layer is BaₐSr_{b}CO_{c}Fe_{d}O₃₋ₑ (wherein a is 0<a<1, b is 0<b<1, c is 0<c<1, d is 0<d<1, e is 0<e<1, a+b=1 and c+d=1). Preferably, the cathode material is Ba_{0.5}Sr_{0.5}CO_{0.8}Fe_{0.2}O₃₋ₑ.

Preferably, the electrolyte material contained in the electrolyte layer includes the electrolyte is formed of ZrO₂ system (CaO, MgO, Sc₂O₂, Y₂O₃ doped ZrO₂), CeO₂ system (Sm₂O₃, Gd₂O₂, Y₂O₃ doped CeO₂), Bi₂O₃ system (CaO, SrO, BaO, Gd₂O₃, Y₂O₃ doped Bi₂O₂), perovskite oxide ((La,Sr)(Ga,Mg)O_{3-δ}, Ba(Ce,Gd)O_{3-δ}, 0≦δ<1) and the like.

Substantially, the anode material contained in the anode layer may use a mixture of Ni oxide and the electrolyte material. However, in the embodiment, a mixture of Y₂O₃ doped ZrO₂ was used.

Preferably, the metal supporter of the metal supported SOFC is formed into a plate type having a through-hole formed in a thickness direction, and fuel is supplied through the through-hole to the anode.

The metal supporter may be formed of SUS400 series, Inconel or Crofer.

Preferably, the metal supported SOFC is a middle/low temperature SOFC, and the operation temperature in the normal operation is 700˜900° C.

The sintering of the green cathode layer is performed upon initially increasing the temperature for the operation of the metal supported SOFC(SOFC having the green cathode), and the cathode layer may be additionally sintered by repeated on/off operation or the normal operation at an operation temperature.

Preferably, the heating rate to the operation temperature is 2.67˜3.33° C./min.

The green cathode layer may be formed by tape casting, screen-printing, spin coating, spray coating or dipping. Preferably, the green cathode layer is formed by the screen-printing.

In order to provide high interface bonding property, proper densification level for porosity, restriction of moving a material along with the electrolyte layer at a bonding area, sintering property that most of driving force is exhausted during the heating process to the operation temperature, stable and low resistance (ASR; area specific resistance) in the operation temperature, and stable ASR property in the low frequency region, the cathode material contained in the cathode layer is BaₐSr_{b}CO_{c}Fe_{d}O₃₋ₑ (wherein a is 0<a<1, b is 0<b<1, c is 0<c<1, d is 0<d<1, e is 0<e<1, a+b=1 and c+d=1). Preferably, the cathode material is Ba_{0.5}Sr_{0.5}CO_{0.8}Fe_{0.2}O₃₋ₑ. The cathode material contained in the cathode slurry has an average particle size of 1˜30 μm. Further, it is preferable that the cathode material contained in the cathode slurry has unimodal particle size distribution.

The cathode slurry may contain an organic material or an organic solvent for controlling viscosity, adhesion and dispersibility. Plasticizer out of dispersing agent, plasticizer, binder and solvent which can be used in preparing the slurry functions to weaken traction force among molecules of a high molecular substance, thereby providing flexibility to the slurry. The binder is absorbed on surfaces of ceramic particles. The binder functions to maintain binding force among particles, delay sedimentation velocity of the particle and increase viscosity and moving speed of liquid phase. The dispersing agent promotes a dispersing process so that various particles are uniformly distributed in the slurry.

Preferably, in the cathode slurry, the cathode powder and ink, in which 95˜99 weight % of dispersing agent and 1-5 weight % of binder are added, are mixed in a weight ratio of 1:0.6. Preferably, the dispersing agent is a-terpineol, and the binder is polyvinyl butyral resin or Butvar.

In order to provide the uniform sintering property and the strength against thermal shock and the proper porosity, preferably, the cathode layer has a thickness of 10-30 μm.

### ADVANTAGEOUS EFFECTS

According to the manufacturing method of the present invention, since the cathode layer is sintered during heating temperature to a normal operation temperature without separate heat treatment, it is possible to prevent the degradation of the metal supporter and also it is possible to reduce the fabricating time and process, thereby reducing the fabricating cost.

Further, the cathode layer formed by the in-situ sintering shows the excellent electrochemical property having the ASR which is very low at a low frequency region and also stable against heat cycle.

### BEST MODE

### Embodiment

After Powder of Ba(NO₃)₂, Sr(NO₃)₂, Co(NO₃)₂.6H₂O and Fe(NO₃)₃.9H₂O was weighed so that a mole ratio of Ba:Sr:Co:Fe was 0.5:0.5:0.8:0.2, and then injected into DI water, glycine was added and stirred. Herein, 80 g of glycine was added per 100 g of the entire powder that was injected into the DI water.

Then, using a hot plate and a heat band, temperature thereof was increased to 350° C. until a synthesis reaction was voluntarily occurred. After the synthesis reaction, synthesized particles were separated from the DI water and the calcined in an air atmosphere of 1000° C. so that the synthesized powder had perovskite phase. (hereinafter, Ba_{0.5}Sr_{0.5}CO_{0.8}Fe_{0.2}O₃₋ₑ, (0<e<1) having the perovskite phase is called BSCF5582.)

After the heat treatment, the BSCF5582 powder was passed through a 100 um sieve and then a 38 um sieve. The sieved BSCF5582 powder was wet ball-milled for 24 hours and then dried, such that the final BSCF5582 powder had an average particle size of 3 um.

In order to prepare an electrolyte, Yttrium Stabilized Zirconia (YSZ) was treated by uniaxial pressing at a pressure of 2 ton so as to be formed into pellets, and then sintered for 4 hours at 1500° C., thereby preparing a pellet type electrolyte.

Then, after 14.7 g of a-terpineol and 0.3 g of Butvar were mixed per 10 g of the prepared BSCF5582 so as to prepare a cathode slurry, the cathode slurry was screen-printed on the electrolyte pellet so as to have a thickness of 15 μm, thereby forming a green cathode layer.

The metal supported SOFC having the green cathode layer was heated to an operation temperature of 800° C. with a heating rate of 2.67˜3.33° C./min so as to form the cathode layer, and then the electrochemical property of the in-situ sintered cathode layer was studied.

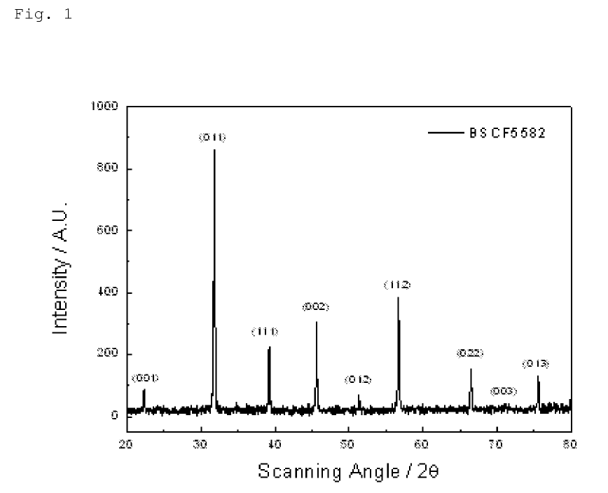

FIG. 1 shows a result of X-ray diffraction of the BSCF5582 formed by thermally treating GNP-synthesized powder in an embodiment of the present invention. As shown in FIG. 1, it can be understood that the synthesized powder has the perovskite phase due to the heat treatment, and there are not other phase and other impurity except the BSCF5582.

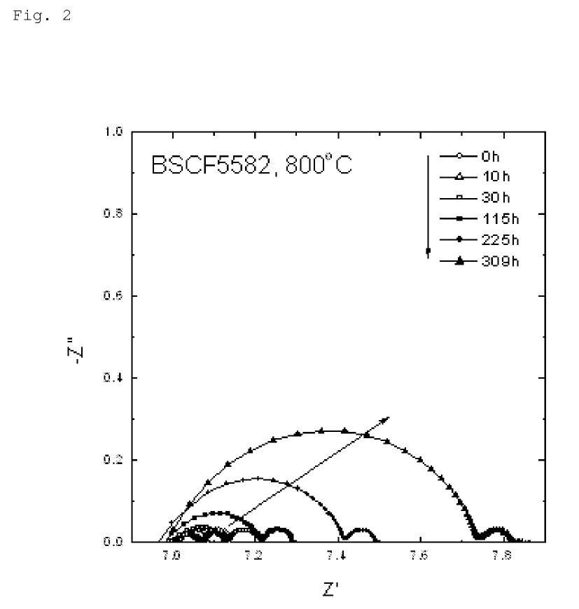

FIG. 2 is a graph showing a result of measuring an impedance Z of a cathode layer (BSCF5582), after a temperature is increased to an initial normal operation temperature (800° C.), according to each normal operation time (0 h, 10 h, 30 h, 115 h, 225 h and 309 h). Herein, the operation time of 0 h means directly after the metal supported SOFC having the green cathode layer is increased to 800° C.

In case of the cathode layer of BSCF5582, it shows a tendency that an ASR value is generally increased as time goes by. However, since the ASR value is very small comparing with other materials, it is proper that the material is used as the cathode of the metal supported SOFC. Further, regarding to a resistance in a high frequency range (10 Hz˜1000 Hz), which is known as a resistance directly relevant to the oxygen reduction reaction, it has a resistance value of 0.005˜0.35 Ω·cm².

The following table 1 shows the entire impedance and the impedance in the high frequency range (10 Hz˜1000 Hz) according to each operation time of cathode layer formed of BSCF5582.

| | | ASR in high frequency |
|---|---|---|
| | Entire ASR | range relevant to oxygen |
| Operation time | (Ω · cm²) | reduction reaction (Ω · cm²) |
| 0 h | 0.023 | 0.005 |
| 10 h | 0.034 | 0.018 |
| 30 h | 0.54 | 0.032 |
| 115 h | 0.13 | 0.11 |
| 225 h | 0.215 | 0.195 |
| 309 h | 0.375 | 0.35 |

As shown in FIG. 2 and table 1, in case of BaₐSr_{b}CO_{c}Fe_{d}O₃₋ₑ material (wherein a is 0<a<1, b is 0<b<1, c is 0<c<1, d is 0<d<1, e is 0<e<1, a+b=1 and c+d=1) of the present invention, it satisfies the in-situ sintering characteristic which is the most important factor in the cathode of the metal supported SOFC, and also has a low ASR value.

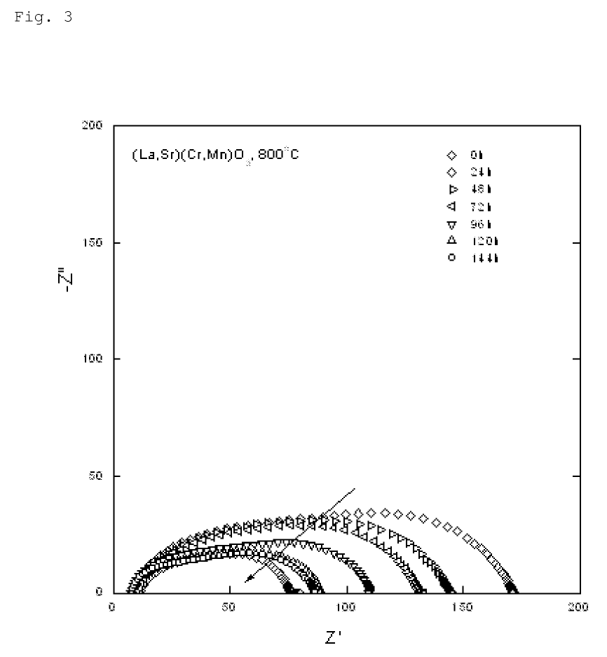

For example, FIG. 3 is a graph showing a result of measuring an impedance after (La,Sr)(Cr,Mn)O_{3-d}(hereinafter, LSCM6482) material, which is a lanthanide system, is used as the green cathode layer and in-situ sintered. After 140 h, it has a resistance value of 40 Ω·cm².

The following table 2 shows a resistance characteristic after BSCF5582 of the present invention and LSCM6482 are in-situ sintered and then normally operated for 100 h.

| Cathode | ASR (Ω · cm²) |
|---|---|
| LSCM6482 | 40 |
| BSCF5582 | 0.13 |

As shown in FIG. 3 and table 2, unlike other material, the cathode layer manufactured by the in-situ sintering of the present invention has the low ASR in a normal operation temperature, and also it has the stable sintering characteristic since most of driving force is exhausted at a heating step to a normal operation temperature. In order to provide the low ASR value, particularly, the low and stable ASR value in the high frequency region, it is preferable that the cathode layer is formed of BaₐSr_{b}CO_{c}Fe_{d}O₃₋ₑ, material (wherein a is 0<a<1, b is 0<b<1, c is 0<c<1, d is 0<d<1, e is 0<e<1, a+b=1 and c+d=1).

In order to facilitate the experiment, the above-mentioned embodiment and the analysis of the electrochemical characteristic of the cathode layer manufactured by the embodiment were carried out with a half cell. However, the manufacturing method of the cathode layer using the in-situ sintering of the present invention and the electrochemical characteristic of the cathode layer manufactured by the method can be applied to a complete cell in which the metal supporter, the anode layer, the electrolyte and the cathode layer are stacked.

When manufacturing the complete cell, the preparing of the anode layer and the bonding of the anode layer and the electrolyte may be performed by the typical manufacturing method of the SOFC. Preferably, the preparing of the anode layer, the bonding of the anode layer and the electrolyte and the bonding of the metal supporter and the anode layer may be performed with reference to Korean Patent Applications Nos. 10-2007-0076133 entitled “combination structure between a unit cell and a separator of SOFC” and 10-2007-0073847 entitled “manufacturing method of an anode and an electrolyte of SOFC”, which are filed by the applicant, or a thesis of the applicant (Journal of Power Sources, 176 (2008), 62-29).

While the present invention has been described with respect to the specific embodiments, it will be apparent to those skilled in the art that various changes and modifications may be made without departing from the spirit and scope of the invention as defined in the following claims.

1. A fabrication method of a metal supported solid oxide fuel cell (SOFC) which comprises a metal supporter, and an anode layer, an electrolyte and a cathode layer stacked in turn on the metal supporter, comprising:
forming the anode layer and the electrolyte on the metal supporter;
forming the green cathode layer by coating on the electrolyte a cathode slurry containing a cathode material; and
in-situ sintering the green cathode layer by a normal operation of the metal supported SOFC.

2. The fabrication method of claim 1, further comprising:
preparing a half cell having the anode layer and the electrolyte by sintering a green cell in which an anode sheet and an electrolyte sheet are stacked, a green cell in which a previously sintered pellet type anode layer and the electrolyte sheet are stacked, or a green cell in which the anode sheet and a previously sintered thin film type electrolyte layer are stacked;
bonding the anode layer of the half cell and the metal supporter;
forming the green cathode layer by coating a cathode slurry on the electrolyte layer of the half cell; and
heating the metal supported SOFC to an operation temperature and then operating it in a status that the green cathode layer is not sintered.

3. The fabrication method of claim 1, wherein the cathode material contained in the cathode layer is BaaSrbCocFedO3-e (wherein a is 0<a<1, b is 0<b<1, c is 0<c<1, d is 0<d<1, e is 0<e<1, a+b=1 and c+d=1).

4. The fabrication method of claim 3, wherein the cathode material is Ba0.5Sr0.5Cu0.8Fe0.2O3-e.

5. The fabrication method of claim 1, wherein the operation temperature in the normal operation is 700˜900° C.

6. The fabrication method of claim 5, wherein the green cathode layer is formed by tape casting, screen-printing or spray coating.

7. The fabrication method of claim 5, wherein the cathode material contained in the cathode slurry has an average particle size of 1 to 30 μm.

8. The fabrication method of claim 7, wherein the cathode layer has a thickness of 10˜30 μm.

9. The fabrication method of claim 2, wherein the operation temperature in the normal operation is 700˜900° C.

10. The fabrication method of claim 3, wherein the operation temperature in the normal operation is 700˜900° C.

11. The fabrication method of claim 4, wherein the operation temperature in the normal operation is 700˜900° C.
